(19) United States
(12) Patent Application Publication
(10) Pub. No.: US 2004/0210462 A1
(43) Pub. Date: Oct. 21, 2004

(54) COMPUTER-IMPLEMENTED SYSTEM AND METHOD FOR REPLICATING STANDARD PRACTICES

(75) Inventors: Dar Wolford, Northville, MI (US); Manjula V. Moola, Farmington Hills, MI (US); Phillip Bond, Dearborn, MI (US); Stanley Henry Kwiecien, Ypsilanti, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/249,502

(22) Filed: Apr. 15, 2003

(51) Int. Cl. G06F 17/60

(52) U.S. Cl. 705/7

(57) ABSTRACT

One aspect of the present invention is related to a computer-implemented system for replicating standard business practices in an organization and having a plurality of business units (BUs). The system generally comprises at least one computer configured to: receive a standard business practice from at least one BU using the standard business practice, receive benchmark information for the standard business practice with the aid of the at least one BU using the standard business practice, transmit the standard business practice with the benchmark information to a plurality of BUs for implementation, and receive feedback regarding the business practice from the plurality of BUs. The feedback is used to determine if the benchmark information used to implement the standard business practice requires revision.

### BACKGROUND OF INVENTION

1. Field of the Invention

One aspect of the present invention includes a computer-implemented method and system for replicating standard business practices in an organization having a plurality of business units, otherwise referred to as BUs.

2. Background Art

In today's complex business environment, organizations commonly have multiple business units, otherwise referred to as BUs, that are commonly comprised of multiple facilities. With respect to manufacturing organizations, such as automotive companies, some of these facilities are plants. These plants often use processes that can be documented and repeated to save time and reduce redundancies.

In complex organizations, the identification of repeatable processes can be carried out by various entities. Individual plants can identify practices for replication. However, these practices are rarely used at other plants, since effective methods for implementing the use of the practice do not exist. For example, benefits of a standard practice are usually not identified, making implementation difficult since other plants do not appreciate the advantages to using the standard practice. Additionally, management commonly identifies practices for standardization. Management often defines standard practices by identifying implementation pieces from several different plants. The resulting standard practice is typically new to the individual plants, leading to costly and time-consuming implementation and resistance by the individual plants in using the standard practice. Moreover, a systematic method for tracking the value, cost and timing of implementation of management's standard practices does not exist.

A computer-implemented method and system for replicating standard practices is needed. This method and system should be able to replicate standard practices without creating new practices. A method and system is also needed that replicates standard practices by receiving feedback from the plants implementing the standard practices.

### SUMMARY OF INVENTION

One aspect of the present invention is a computer-implemented method and system for replicating standard practices. Another aspect of the present invention is a method and system that replicates standard practices without creating new practices. Yet another aspect of the present invention includes a method and system that replicates standard practices by receiving feedback from the plants implementing the practices. Another aspect of the present invention is a method and system that allows users that identify standard practices to define the benefits of the practice. Moreover, the methods and systems of the present invention utilize visual references, for example, digital video, audio, web-linked attachments, etc., in replicating standard practices.

One preferred computer-implemented method embodiment of the present invention for replicating standard business practices includes receiving a standard business practice from at least one BU using the standard business practice, receiving benchmark information for the standard business practice with the aid of the at least one BU using the standard business practice, transmitting the standard business practice with the benchmark information to a plurality of BUs for implementation, and receiving feedback regarding the business practice from the plurality of BUs. The feedback is used to determine if the benchmark information used to implement the standard business practice requires revision.

In a method preferred embodiment, the standard business practice can be identified by: receiving a business process from at least one BU using the business process, comparing the business process with standard business criteria, and, if the business process meets the standard process criteria, identifying the business process as the standard business practice and the at least one BU using the business process as the at least one BU using the standard business practice. Additionally, the plurality of BUs can be required to provide feedback. The benchmark information can be comprised of deliverables and measurables. The aid of the at least one standardizing BU can be secured by providing an incentive, for example, budgetary relief or business recognition.

One preferred computer-implemented system embodiment of the present invention for replicating standard business practices includes at least one computer configured to: receive a standard business practice from an at least one BU using the standard business practice, receive benchmark information for the standard business practice with the aid of the at least one BU using the standard business practice, transmit the standard business practice with the benchmark information to a plurality of BUs for implementation, and receive feedback regarding the business practice from the plurality of BUs. The feedback is used to determine if the benchmark information used to implement the standard business practice requires revision and/or to gauge the progress of implementation of the standard business practice.

In a preferred system embodiment, the plurality of BUs can be required to provide feedback. Additionally, benchmark information can be comprised of deliverables and measurables. Moreover, the aid of at least one standardizing BU can be secured by providing an incentive, for example, budgetary relief or business recognition.

The above and other objects, features, and advantages of the present invention are readily apparent from the following detailed description of the best mode for carrying out the invention when taken in connection with the accompanying drawings.

### BRIEF DESCRIPTION OF DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings which:

FIG. 1 is a schematic diagram illustrating a preferred embodiment of a system for implementing the present invention;

FIG. 2 is a block flow diagram illustrating a preferred methodology for implementing the present invention;

FIGS. 3a and 3b are a preferred web browser interface for displaying detailed implementation information in accord with one embodiment of the present invention; and

FIG. 4 is a preferred web browser interface for providing feedback to an approved practice in accord with one embodiment of the present invention.

### DETAILED DESCRIPTION

As required, detailed embodiments of the present invention are disclosed herein. However, it is to be understood that the disclosed embodiments are merely exemplary of the invention that may be embodied in various and alternative forms. Therefore, specific functional details are not to be interpreted as limiting, but merely as a representative basis for the claims and/or as a representative basis for teaching one skilled in the art to variously employ the present invention.

One aspect of the present invention relates to a computer-implemented system for replicating standard business practices in an organization having a plurality of business units, otherwise referred to as BUs. The system generally comprises a computer configured to: receive a standard business practice from an at least one BU using the standard business practice, receive benchmark information for the standard business practice with the aid of the at least one BU using the standard business practice, transmit the standard business practice with the benchmark information at a plurality of BUs for implementation, and receive feedback regarding the business practice from the plurality of BUs. The feedback is used to determine if the benchmark information used to implement the standard business practice requires revision and/or to gauge the progress of implementation of the standard business practice.

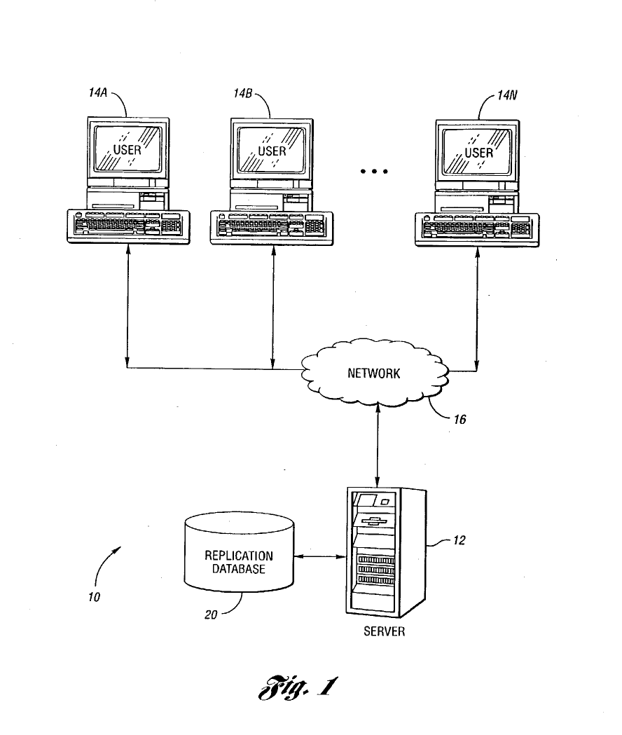

FIG. 1 is a schematic diagram illustrating a preferred system 10 for implementing the present invention. FIG. 1 illustrates an at least one server computer 12 operably serving a plurality of BU computers 14A-14N through computer network 16. BU computers can be used by individuals involved in the replication function, such as administrators, which edit practice content and review the feedback, as described in more detail below. The at least one server computer 12 is operably configured to store information to, and retrieve information from, at least one replication database 20. Computer network 16 can be comprised of any one or more of a variety of computer communication configurations including but not limited to a local area network (LAN), a wide area network (WAN), a wireless network, an intranet, an extranet and the Internet. Preferably, computer network 16 is an intranet and system 10 is protected by a firewall.

Another aspect of the present invention relates to a computer-implemented method for replicating standard business practices in an organization having a plurality of BUs. The method generally comprises: receiving a standard business practice from an at least one BU using the standard business practice, receiving benchmark information for the standard business practice with the aid of the at least one BU using the standard business practice, transmitting the standard business practice with the benchmark information at a plurality of BUs for implementation, and receiving feedback regarding the business practice from the plurality of BUs. The feedback is used to determine if the benchmark information used to implement the standard business practice requires revision and/or to gauge the progress of implementation of the standard business practice.

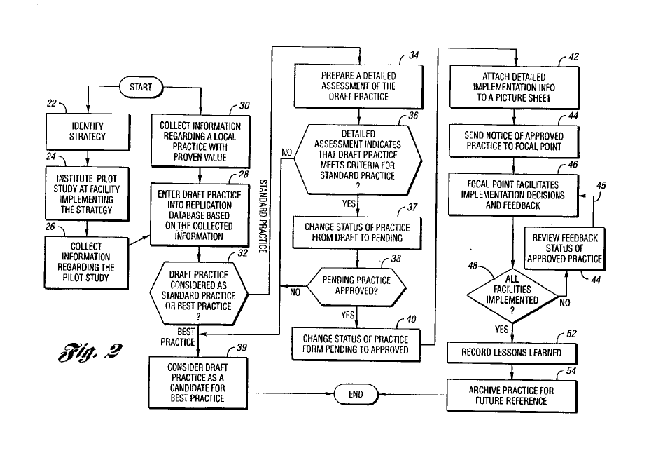

FIG. 2 is a block flow diagram illustrating a preferred methodology for implementing the present invention.

As depicted in block 22 of FIG. 2, a strategy is identified. It should be understood that a strategy is a long-lead project having significant investment and payback potential. For example, a strategy can be the scheduling of ultra-sonic leak testing to (1) check fittings while equipment is operating, using specified procedures at the optimum time interval prior to the scheduled maintenance period, (2) tag leaks, and (3) fix a line having leaks when it is scheduled for maintenance. Preferably, funding for strategies are incorporated into the business plan and strategies are identified through plant manager conferences. Strategies provide the foundation for identifying and defining practices. It should be understood that a practice refers to a proven improvement to a business process. Preferably, various status levels for practices are defined. Status levels contemplated by the present invention include, but are not limited to, draft, pending, approved, and archived. These status levels are described in greater detail below.

As depicted in block 24, the identified strategy is implemented by instituting a pilot study at a facility. The preferred methodology is implemented in an organization having a plurality of BUs wherein each BU is comprised of at least one facility. A non-limiting example of a facility is a plant, more specifically a manufacturing plant, and most specifically a stamping plant.

As depicted in block 26, information regarding the pilot study is collected. The information collected includes, but is not limited to, a benchmarking of common equipment processes and procedures using common methods and metrics to collect data at all locations. The facility conducting the pilot study should supply sufficient detail to rapidly and effectively replicate, as well as detailed rationale for replication.

As depicted in block 28, a draft practice is entered into replication database 20 based on the collected information. The information collected regarding the pilot study on the strategy is used as the basis for the draft practice. The draft status of the practice is used to describe strategy submissions that are incomplete or have not been reviewed. At the draft status level, an originator may edit, add/delete attachments to the draft practice as required. The originator refers to a person who has the most knowledge about the practice.

As depicted in block 30, information can be collected regarding a local process with proven value. Preferably, a plant committee reviews local processes with proven value and selects a local process for submission. Preferably, processes are not considered for submission unless (1) the process is currently in place within a organization or (2) the process has been directed by BU leadership. If directed by corporate leadership, the process should be successfully piloted at a facility and replicable at most other facilities within the organization. Preferably, the process is tangible with proven benefits and are initiated by plants.

The collected information includes, but is not limited to, specific comparisons of productivity, throughput, and waste reduction to identify the best plants.

The process step depicted in block 30 provides an alternative to blocks 22 through 26 for collecting information that forms the basis of the draft practice. The choice of which alternative to use depends on the particular implementation of the present invention.

As depicted in block 32, a decision is made as to whether the draft practice should be considered for a standard practice or a best practice. It should be understood that a standard practice is a proven best practice as having high value. BUs typically standardize based on standard practices and plants adopt and implement standard practices. Preferably, the status of implementation is input and updated at the plant level. The plant can generate reports for review by BU leadership. It should be understood that a best practice refers to a process, technology or business process that has proven value with measurable results. Preferably, adoption and implementation of a best practice is entirely at the discretion of a plant interested in the best practice.

If the draft practice is ear-marked as a candidate for a standard practice, a detailed assessment of the draft practice is prepared, as depicted in block 34. Preferably, a standard practice gatekeeper forwards the draft practice to a staff proponent for evaluation. The staff proponent prepares the detailed assessment.

As depicted in block 36, the detailed assessment reveals whether the draft practice meets the criteria for a standard practice. Preferably, the draft practice meets the criteria if it has clearly superior attributes and is believed to be the single best way to perform an activity. If the draft practice meets the standard, it is elevated to pending practice status level, as depicted in block 37. At the pending level, the practice has been reviewed by the gatekeeper and the appropriate staff proponent, but has not been reviewed by the BU leadership for final approval. If the detail assessment indicates that the draft practice does not meet the criteria for a standard practice, the draft practice may still be considered as a candidate for a best practice, as depicted in block 39.

As depicted in block 38, the pending practice is reviewed for final approval. The pending practice is preferably reviewed by corporate leadership. If approved, the practice is set to approved status level, as depicted in block 40. At the approval level, the practice has been approved by BU leadership and periodic feedback from each plant is preferably required to produce a plant summary report for BU leadership. If not approved, the pending practice may still be considered as a candidate for a best practice, as depicted in block 39.

As depicted in block 42, detailed implementation information, otherwise referred to as benchmark information, regarding the approved practice is attached to a picture sheet. The picture sheet refers to a document that can be displayed as a GUI. This information is preferably collected by an at least one BU that already uses the approved standard. Preferably, this BU is provided with an incentive to not only cooperate with the information gathering but also to promote future best practice identification. Examples of incentives, include, but are not limited to, budgetary relief and business recognition.

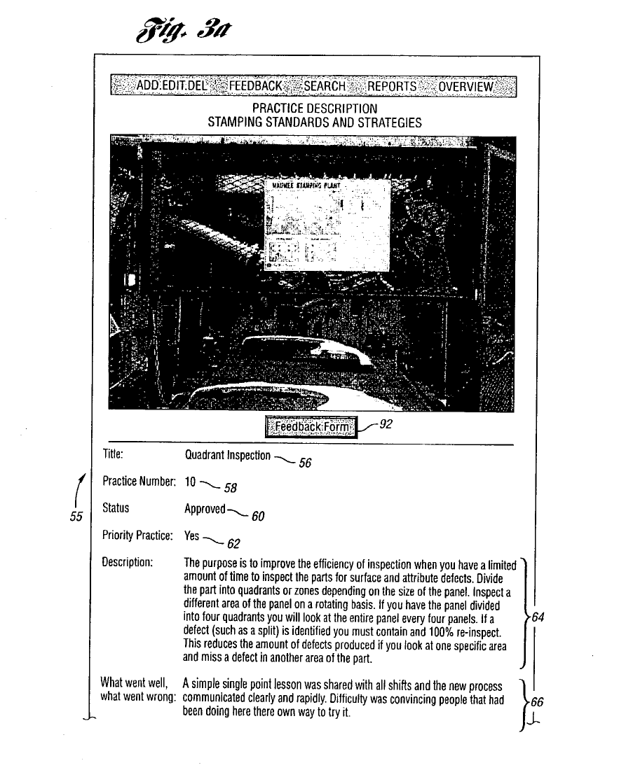

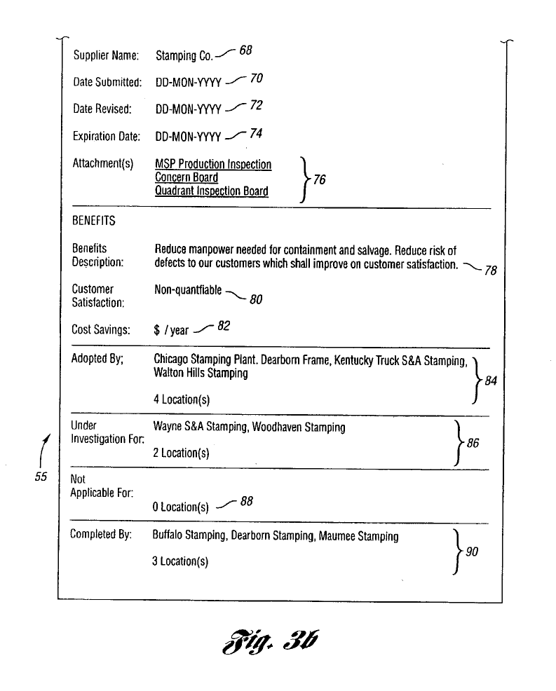

FIGS. 3a and 3b are a preferred web browser interface 55 for displaying detailed implementation information in accord with one embodiment of the present invention. Web browser interface 55 displays detailed implementation information for the “Quandrant Inspection” practice description. It should be understood that FIG. 3 is merely illustrative of one of many standard practices that can be replicated in accordance with the present invention. Web browser interface 55 includes, but is not limited to the fields for displaying information: title 56, practice number 58, practice status 60, priority practice status 62, description 64, lessons learned description 68, supplier name 68, date submitted 70, date revised 72, expiration date 74, attachment(s) 76, benefits description 78, cost savings 80, plant adoption list 84, under investigation list 86, not applicable list 88, and completed by list 90. Attachment(s) 76 lists links to documents related to the best practice, for example, production inspection documents, concern board documents, and inspection board documents. Web browser interface also includes “Feedback Form” button 92 that links to a feedback web browser interface, discussed in greater detail below.

It should be understood that keyword searches can be conducted on many of the fields displayed on web browser interface 55. For example, keyword searches can be conducted on the title field, practice number field, or description field to locate a specific best practice matching the keywords.

As depicted in block 44, focal points receive notice of approved practices, preferably via e-mail. Focal points refer to individuals habitually assigned to facilities, preferably plants, that have been identified to provide feedback on the approved practice.

As depicted in block 46, the focal points facilitate implementation decisions and feedback. Preferably, feedback is provided in the form of an implementation plan or inhibitors with associated costs or savings.

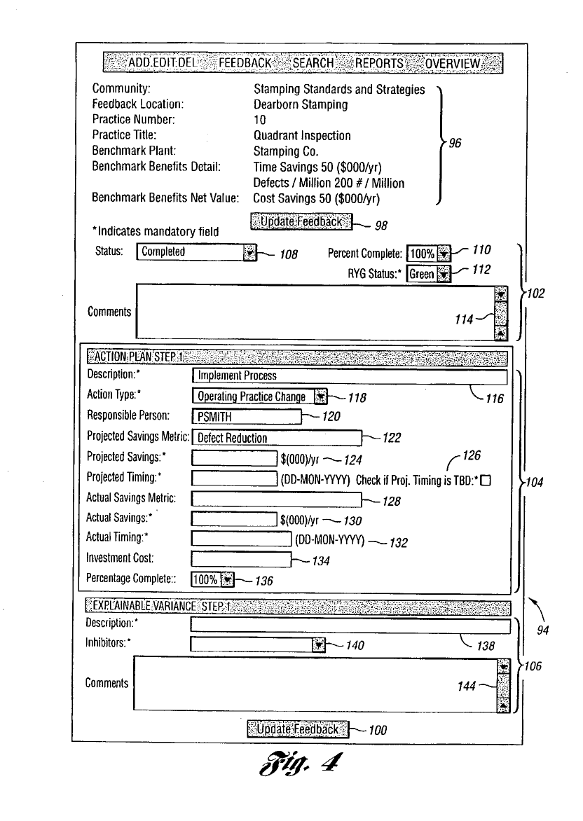

FIG. 4 is a preferred web browser interface 94 for providing feedback to an approved practice in accord with one embodiment of the present invention. Web browser interface 94 preferably includes feedback information block 96, which includes, but is not limited to, community, feedback location, practice number, practice title, benchmark plant, benchmark benefits detail, and benchmark benefits net value. Web browser interface 94 also includes update feedback buttons 98 and 100 for updating the entered feedback information. Data fields on web browser interface 94 for providing user feedback information, can include, but are not limited to overall feedback information 102, action plan step information 104, and explainable variance step information 106. Overall feedback information can include, but is not limited to, status 108, percent complete 110, RYG Status 112, and comments 114. It should be understood that RYG refers to a color coding system for defining the progress of a plant's feedback. R (red) refers to “no plan, no progress”. Y (yellow) refers to “have plan, some progress”. G (green) refers to “on track”. It should be understood that information can be entered for multiple action steps. Action plan step information 104 can include, but is not limited to, description 116, action type 118, responsible person 120, projected savings metric 122, projected savings 124, projected timing 126, actual savings metric 128, actual savings 130, actual timing 132, investment cost 134, and percentage complete 136. Explainable variance step information can include description 138, inhibitors 140, and comments 144. It should be understood that information can be entered for multiple explainable variance steps.

As depicted in block 48, the implementation status is checked. If less than all the plants have implemented the standard practice, the feedback status of the approved practice are reviewed, as depicted in block 44. After the feedback status has been checked, the feedback is given again based on any deficiencies found in the feedback status, as depicted in line 45 and block 46.

If all the plants have implemented the standard practice, lessons learned are recorded, as depicted in block 52, and the standard practice is archived for future reference, as depicted in block 54. At the archived status level, the plant feedback is no longer required for the plant summary report.

Standard practices are preferably replicable for most plants and have a measurable benefit to the execution of an organization. Consequently, it is expected that most of the feedback based on the standard practice will indicate some financial benefit.

As depicted in block 39, a draft practice can be considered as a candidate for a best practice. The draft practice can be approved as a best practice based on a review of the draft practice. If the draft practice is not approved, the gatekeeper deletes the draft practice and e-mails originator. If the draft practice is approved, the status of the practice is elevated to approved. Preferably, the best practices gatekeeper changes the status to approved. Plant focal points receive notice of approved practice, preferably via e-mail. The approved practice is reviewed to determine whether to implement the practice. Preferably, the best practice release is reviewed by a plant committee to determine whether to implement the practice. The plant committee should be chaired by a person of sufficient knowledge, experience and influence to recognize a good idea and the ability to take rapid, appropriate action. The plant focal point inputs appropriate feedback status. The feedback status is checked. If the feedback is not complete, the feedback status of the approved practices are reviewed. After the feedback status has been checked, the feedback is given again based on any deficiencies found in the feedback status. If all the feedback is complete, lessons learned are recorded and the standard practice is archived for future reference. At the archived level, the plant feedback is no longer required for the plant summary report.

While the best mode for carrying out the invention has been described in detail, those familiar with the art to which this invention relates will recognize various alternative designs and embodiments for practicing the invention as defined by the following claims.

1. A computer-implemented system for replicating standard business practice in an organization having a plurality of business units (BUs), the system comprising at least one computer configured to:
receive a standard business practice from an at least one BU using the standard business practice;
receive benchmark information for the standard business practice with the aid of the at least one BU using the standard business practice;
transmit the standard business practice with the benchmark information to a plurality of BUs for implementation; and
receive feedback regarding the business practice from the plurality of BUs, wherein the feedback is used to determine if the benchmark information used to implement the standard business practice requires revision.

2. The computer-implemented system of claim 1 wherein the standard business practice is identified by configuring the at least one computer to:
receive a business process from at least one BU using the business process;
compare the business process with standard business criteria; and
if the business process meets the standard process criteria, identify the business process as the standard business practice and the at least one BU using the business process as the at least one BU using the standard business practice.

3. The computer-implemented system of claim 1 wherein the standard business practice is identified by configuring the at least one computer to:
receive a plurality of business processes with respect to a strategy from a plurality of BUs using at least one of the plurality of business process related to the strategy;
compare the plurality of business processes with standard business criteria; and
identify one business process from the plurality of business processes as the standard business practice and an at least one BU using the one business process as the at least one BU using the standard business practice, wherein the one business process is identified as most closely comparing to the standard business criteria.

4. The computer-implemented system of claim 1 wherein the plurality of BUs are required to provide feedback.

5. The computer-implemented system of claim 1 wherein the benchmark information is comprised of deliverables and measurables.

6. The computer-implemented system of claim 1 wherein the aid of the at least one standardizing BU is secured by providing an incentive.

7. The computer-implemented system of claim 6 wherein the incentive is comprised of budgetary relief for the at least one standardizing BU.

8. The computer-implemented system of claim 6 wherein the incentive is comprised of business recognition for the at least one standardizing BU.

9. A computer-implemented system for replicating standard business processes in an organization having a plurality of business units (BUs), the system comprising:
a means for receiving a standard business practice from at least one BU using the standard business practice;
a means for receiving benchmark information for the standard business practice with the aid of the at least one BU using the standard business practice;
a means for transmitting the standard business practice with the benchmark information to a plurality of BUs for implementation; and
a means for receiving feedback regarding the business practice from a plurality of BUs,
wherein the feedback is used to determine if the benchmark information used to implement the standard business practice requires revision.

10. The computer-implemented system of claim 9 further comprising:
a means for receiving a business process from at least one BU using the business process;
a means for comparing the business process with standard business criteria; and
if the business process meets the standard process criteria, a means for identifying the business process as the standard business practice and the at least one BU using the business process as the at least one BU using the standard business practice.

11. The computer-implemented system of claim 9 wherein the plurality of BUs are required to provide feedback.

12. The computer-implemented system of claim 9 wherein the benchmark information is comprised of deliverables and measurables.

13. The computer-implemented system of claim 9 wherein the aid of the at least one standardizing BU is secured by providing an incentive.

14. The computer-implemented system of claim 13 wherein the incentive is comprised of budgetary relief for the at least one standardizing BU.

15. The computer-implemented system of claim 13 wherein the incentive is comprised of business recognition for the at least one standardizing BU.

16. A computer-implemented method for replicating standard business processes in an organization having a plurality of business units (BUs), the method comprising:
receiving a standard business practice from at least one BU using the standard business practice;
receiving benchmark information for the standard business practice with the aid of the at least one BU using the standard business practice;
transmitting the standard business practice with the benchmark information to a plurality of BUs for implementation; and
receiving feedback regarding the business practice from the plurality of BUs, wherein the feedback is used to determine if the benchmark information used to implement the standard business practice requires revision.

17. The computer-implemented system of claim 16 wherein the plurality of BUs are required to provide feedback.

18. The computer-implemented method of claim 16 wherein the benchmark information is comprised of deliverables and measurables.

19. The computer-implemented method of claim 16 wherein the aid of the at least one standardizing BU is secured by providing an incentive.

20. The computer-implemented method of claim 19 wherein the incentive is comprised of budgetary relief for the at least one standardizing BU.
